(19) United States
(12) Patent Application Publication
(10) Pub. No.: US 2005/0239028 A1
(43) Pub. Date: Oct. 27, 2005

(54) Stance guide and method of use

(76) Inventors: Chang Jy Richard Wu, Walnut, CA (US); Howard Chorng-Jeng Wu, Walnut, CA (US)

Correspondence Address: CHEIN-HWA S. TSAO, 6684 MT PAKRON DRIVE, SAN JOSE, CA, 95120, US

(21) Appl. No.: 10/817,340

(22) Filed: Apr. 3, 2004

(51) Int. Cl. G09B 19/00

(52) U.S. Cl. 434/257

(57) ABSTRACT

A stance guide and method of use are disclosed to help a user achieve and hold a number of stances hence providing corresponding health benefits to the user. The stance guide includes an adjustable foot engaging and an adjustable body engaging device, connected to each other with a frame, for guiding and engaging the user's feet and body while accommodating a range of user population. The foot engaging or the body engaging device can include a sensing and signaling device plus a timer to help the user achieve correct stances for a desired time duration. A display device can be included for displaying the stance images as a visual aid. A guard device can be included for reducing the risk of an accidental fall during practice. Specific designs of the stance guide are presented with health benefits of reducing excess urination, enhancing sleep quality and reducing body weight.

### BACKGROUND OF THE INVENTION

1. Field of the Invention

The present invention relates generally to the field of exercise apparatus. More particularity, the present invention is directed to stance guides for helping the user achieve and hold stances for corresponding health benefits.

2. Description of the Related Art

Numerous exercise equipments are available in the market today for a variety of human exercises. Typically a person, as for example in the case of a weight-lifting machine, performs a pre-determined sequence of movements while interacting with and moving certain parts of the exercise equipment to achieve corresponding health benefits. On the other hand, numerous other pseudo-static or even static forms of exercises either exist or are being discovered that also provides the person with health benefits. For example Tai-Ji Chuan from China, also known as shadow boxing, is a pseudo-static exercise known to benefit a person's body flexibility and general health. For another example, Yoga can be classified as a static exercise known to benefit a person's body flexibility and mental clarity. While it is not absolutely required to have an equipment accompanying the pseudo-static or static stances of these exercises, in many cases it is nevertheless helpful or even highly desirable to provide an accompanying equipment to guide and assist the user so as to increase the easiness and efficiency for achieving these stances. This becomes particularly important where achieving and holding certain specific stances are physically strenuous.

### SUMMARY OF THE INVENTION

A stance guide and method of use are proposed to help the user achieve and hold one or more stances Sⱼ, where j=(1, 2, . . . N) and N>=1, so that the achievement and holding of each Sⱼ provides a corresponding health benefit to the user.

The stance guide includes a foot engaging device for guiding and engaging at least one foot of the user, a body engaging device for guiding and engaging at least one part of the user body and a framing structure connected to the foot engaging device and the body engaging device.

Various structural dimensions of the foot engaging device, the body engaging device and the framing structure relevant to guiding and engaging the user's feet and body are made adjustable to accommodate a range of body and feet variation of the user population.

The foot engaging device or the body engaging device of the stance guide can further include a corresponding engagement sensing and signaling device for sensing and signaling the correctness of engagement.

The above engagement sensing and signaling devices can further include a timing device for timing the duration of correct engagement.

The stance guide can further include an attached optional display device for selectably displaying one or more of the stances Sⱼ as a visual aid to achieving and holding the stances Sⱼ.

Where some of the stances Sⱼ require a specific position and orientation of the user's hands, a hand engaging device, as part of the body engaging device, can be added for guiding and engaging the user's hands.

If desirable, the body engaging device or the framing structure can further include a safe guard device for reducing the risk of an accidental fall of the user while trying to achieve and hold the stances Sⱼ.

For the health benefit to be significant, the method of using the stance guide further includes, for each stance Sⱼ, a recommended range of holding period per practice and practicing frequency.

A first set of specific stances S₁, S₂, S₃ and S₄, together with an associated specific stance guide, are proposed to more easily and efficiently provide the health benefits of direct development of stronger body muscles and better body flexibility and indirect strengthening of the bladder muscles and nerves causing a reduction of frequent and excess habitual urination.

A second set of specific stances S₅, S₆, S₇ and S₈, together with an associated specific stance guide, are proposed to more easily and efficiently provide the health benefits of direct development of stronger body muscles and better body flexibility and indirect enhancement of sleep quality and reduction of body weight.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawing, in which like reference characters designate the same or similar parts throughout the several views, and wherein:

FIG. 1A, FIG. 1B, FIG. 1C and FIG. 1D illustrate a first stance, labeled stance S₄, for the user of the present invention to achieve and hold to realize a corresponding health benefit;

FIG. 2A, FIG. 2B, FIG. 2C and FIG. 2D illustrate an intermediary stance of S₄, labeled S₂, and the stance S₄, together with a corresponding stance guide of the present invention, for the user to use thus achieving and holding S₂ and S₄ to realize corresponding health benefits;

FIG. 3 illustrates a second stance, labeled S₃, for the user of the present invention to achieve and hold to realize a corresponding health benefit;

FIG. 4 illustrates another stance, labeled S₈, for the user of the present invention to achieve and hold to realize a corresponding health benefit;

FIG. 5A and FIG. 5B illustrate an intermediary stance of S₈, labeled S₆, together with a corresponding stance guide of the present invention, for the user to use thus achieving and holding S₆ and S₈ to realize corresponding health benefits; and

FIG. 6 illustrates only the stance guide of the present invention for the user to use thus progressively achieving and holding a number of stances S₁, S₂, S₃, S₄, S₅, S₆, S₇ and S₈ to realize a number of corresponding health benefits.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well-known methods, procedures, materials, components and circuitry have not been described in detail to avoid unnecessary obscuring aspects of the present invention. The detailed description is presented largely in terms of simplified perspective views. These descriptions and representations are the means used by those experienced or skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of process flow representing one or more embodiments of the invention do not inherently indicate any particular order nor imply any limitations of the invention.

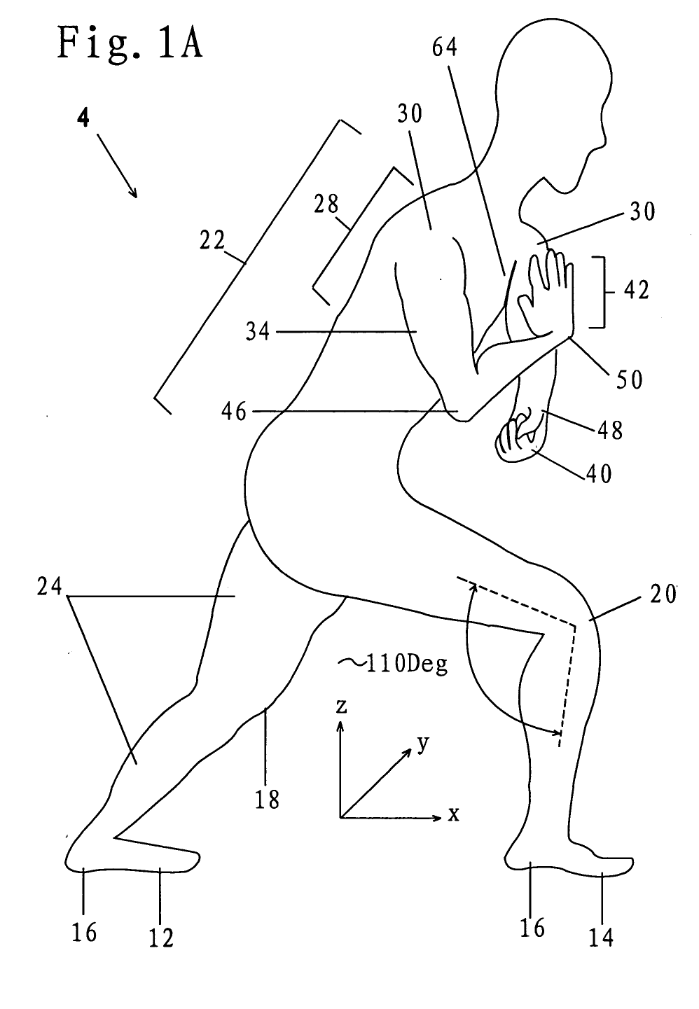

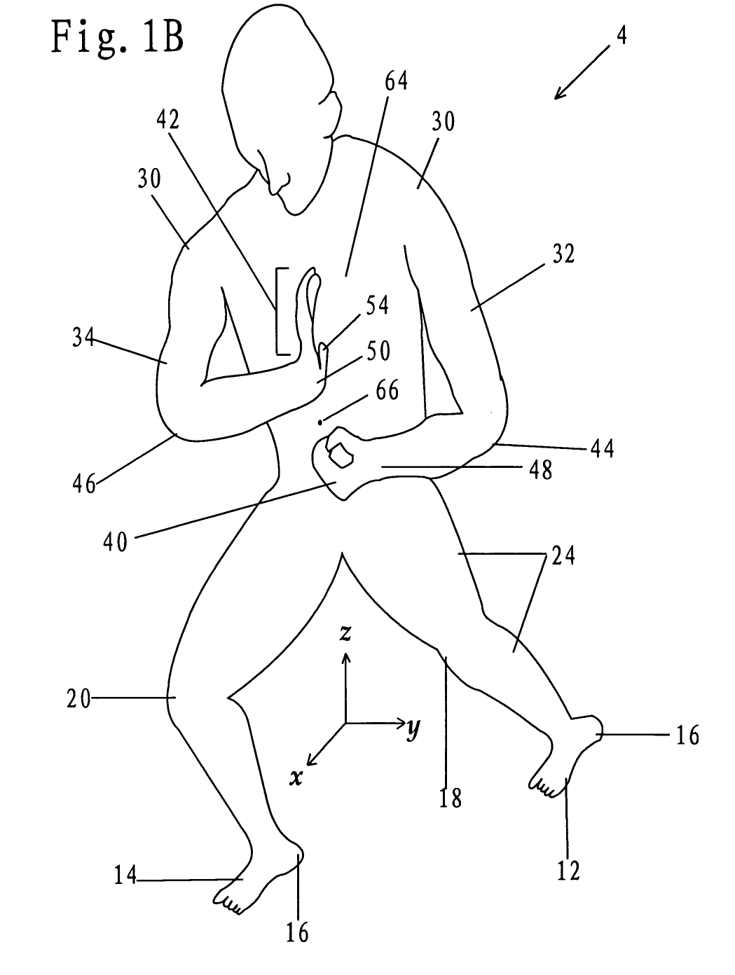

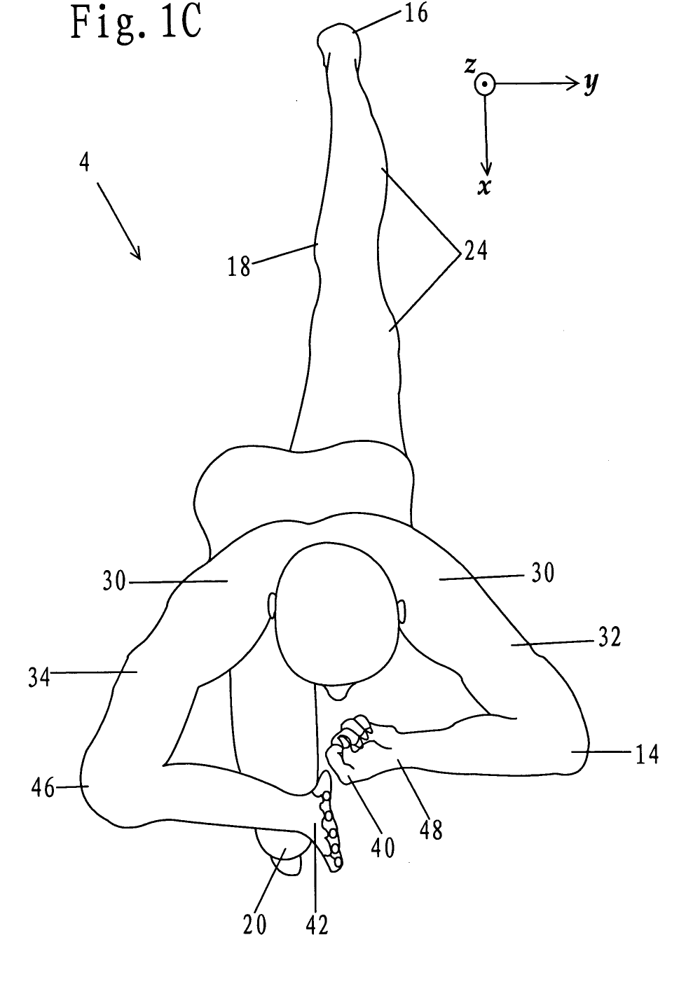

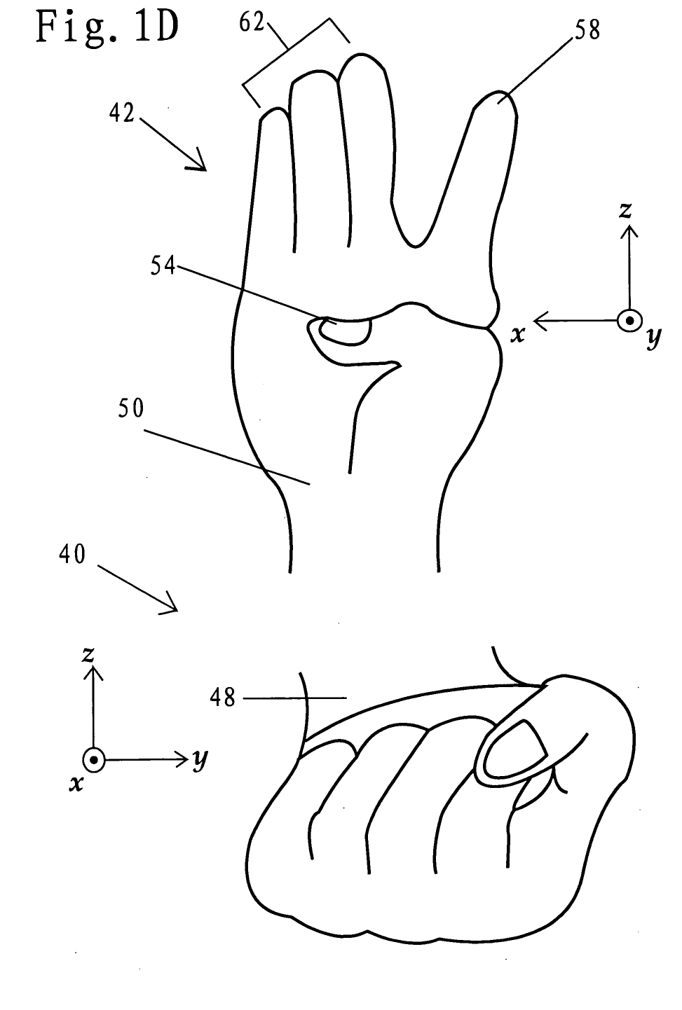

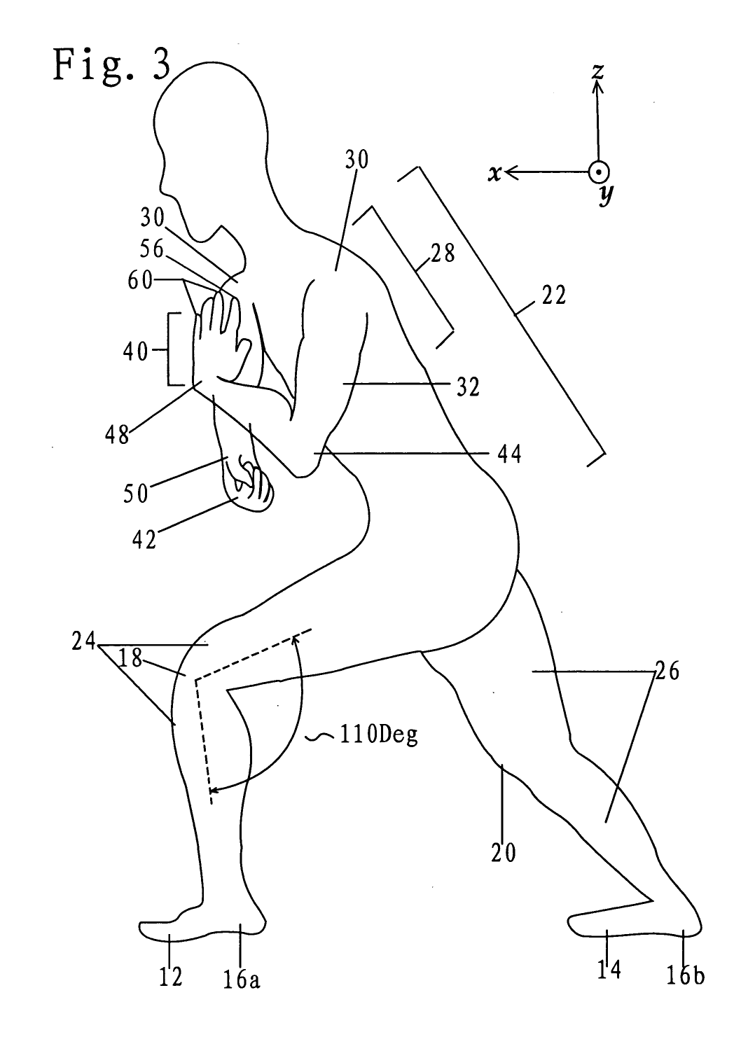

FIG. 1A, FIG. 1B, FIG. 1C and FIG. 1D illustrate a first stance, labeled stance S₄ 4, for the user of the present invention to achieve and hold to realize a corresponding health benefit, to be presently described. FIG. 1A is a side view, FIG. 1B is a front view, FIG. 1C is a top view of the stance S₄ 4 whereas FIG. 1D illustrates the details of the user's hands. To help the illustration, an x-y-z Cartesian coordinate is introduced wherein the x-direction is where the user's body faces, the y-direction runs from the user's right shoulder toward his left shoulder and the z-direction runs vertically upwards. As illustrated, both feet 12 and 14 need to be flat with heels 16 against the ground and centered in a sagittal plane of the body. Right foot 14 is positioned in front of and spaced as far ahead of left foot 12 as possible. Right knee 20 bent at about 110 degrees with left knee 18 stretched as straight as possible while keeping the body weight on the right foot 14. The overall back 22 should form a straight line with the left leg 24. The upper back 28 should be arched and the shoulders 30 curved forward. The upper right arm 34 should be positioned ahead (+x direction) of the upper left arm 32 with the right elbow 46 slightly ahead of (+x direction) the right wrist 50. The right hand 42 should form an open-palm, Christian style praying orientation except having a bent right thumb 54, pointing in the x-direction, and having a right index finger 58 separated from the rest of right fingers 62, the right thumb 54 positioned at the same height as but about five (5) inches ahead of (+x direction) the heart 64. The lower left arm 36 should be pointing approximately in the negative y-direction with the left elbow 44 slightly ahead of (+x direction) the left wrist 48, the left hand 40 made into a fist with palm side up and positioned about three (3) inches below the user's belly button 66 while continuously keeping the body weight on the right foot 14. FIG. 3 illustrates a second stance S₃ 3, that is very similar to and is essentially a mirror image of stance S₄ 4 regarding the positions of left/right foot and left/right arm. For example, in stance S₃ 3 the left foot 12 is positioned in front of and spaced as far ahead of the right foot 14 as possible, etc.

Through practice, it has been found that the achievement and holding of stances S₃ and S₄ on a regular basis provides the following health benefits to many people:
(1) Direct development of stronger body muscles and better body flexibility.

(2) Indirect strengthening of the bladder muscles and nerves causing a reduction of frequent and excess habitual urination for those having these problems.

More elaboration on these health benefits will be presently described.

Notwithstanding the above health benefits of the stances S₃ and S₄, the regular achievement and holding of these stances, given their peculiar nature, can be quite strenuous and challenging to a beginning practitioner. For example, a practitioner can feel tension, sore and slight pain on his calf and back of knees. For another example, a practitioner, due to the in-line positioning of his feet 12 and 14 for stances S₃ and S₄, can even fall from a tendency of body instability in the y-z plane thus giving up on the practice all together. Therefore, the present invention proposes a stance guide together with a method of use to help the user achieve and hold one or more stances Sⱼ, where j=(1, 2, . . . N) and N>=1, so that the achievement and holding of each Sⱼ provides a corresponding health benefit to the user. Furthermore, as some or all of the stances Sⱼ can appear to be quite complex thus intimidating to a beginning practitioner, each stance Sⱼ can optionally be broken down into a sequence of one or more progressively simplified, intermediary stances each utilizing a corresponding portion of the stance guide together with a corresponding method of use to increase the easiness and efficiency for bridging, for example, an intermediary stance of S₃ to the ultimate stance S₃.

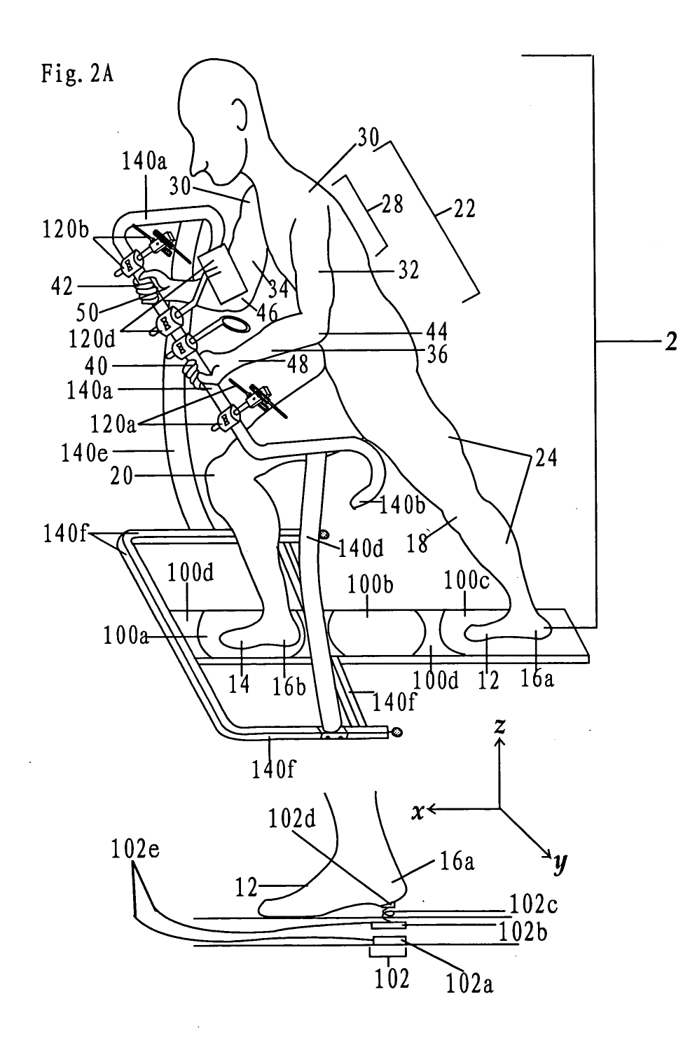

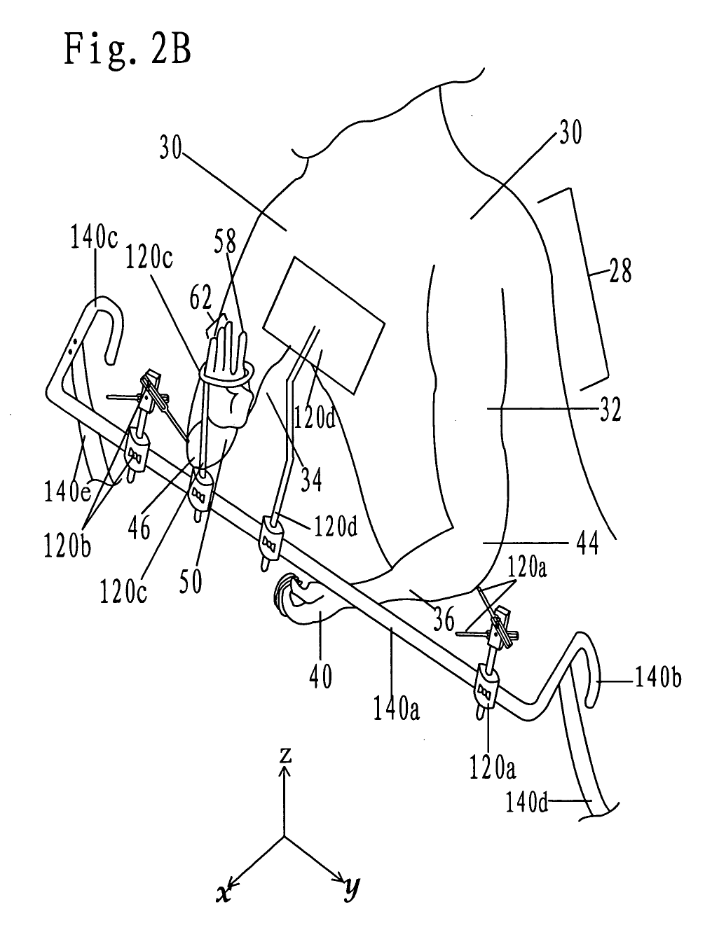

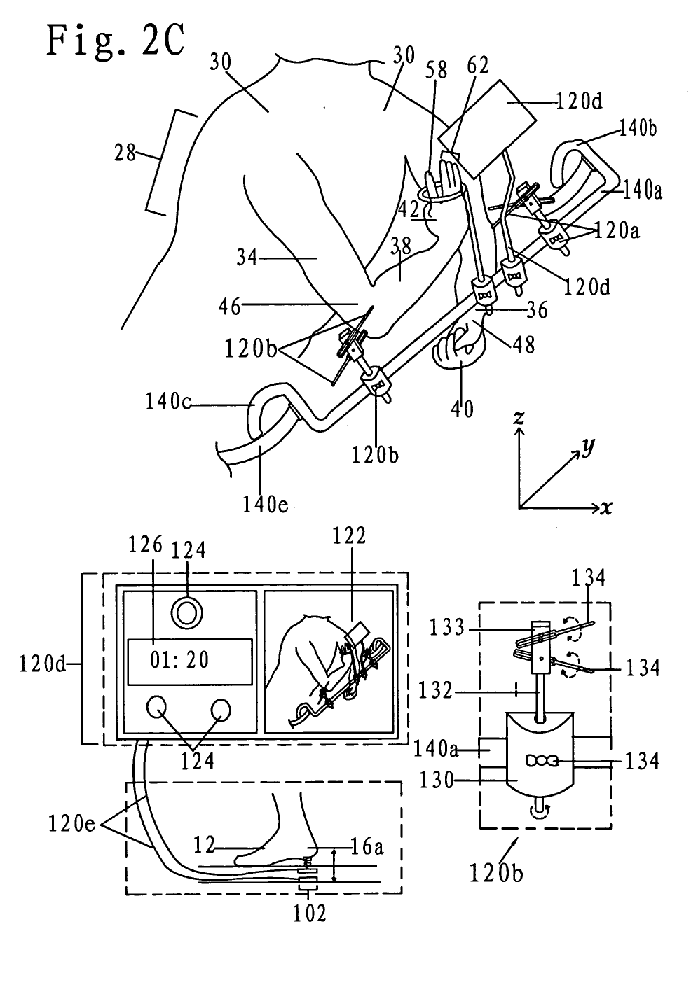

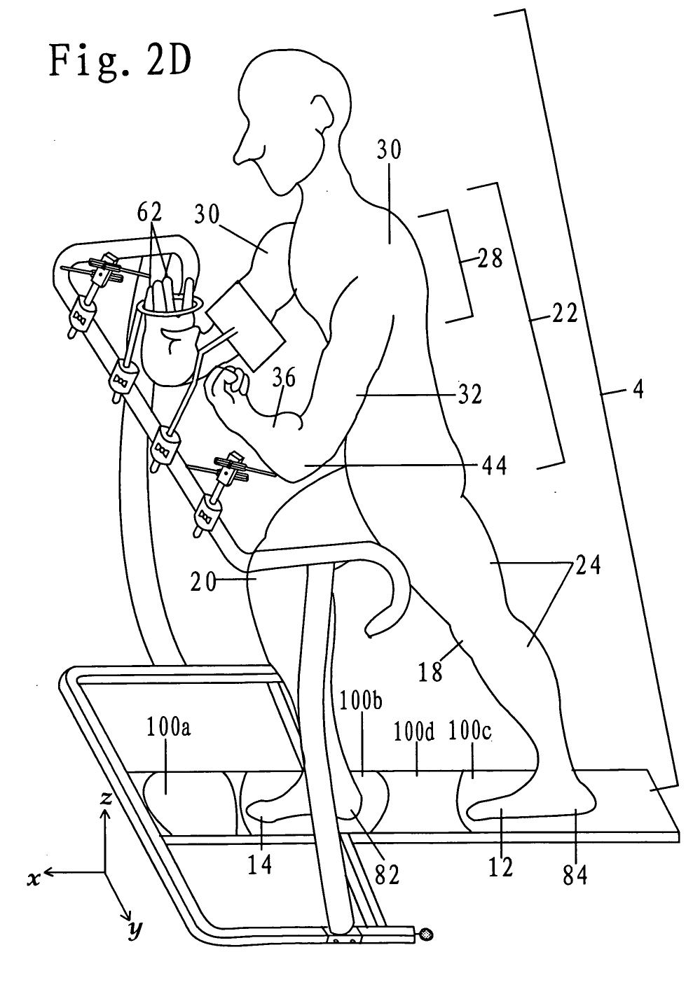

FIG. 2A, FIG. 2B, FIG. 2C and FIG. 2D illustrate an intermediary stance of stance S₄ 4, labeled stance S₂ 2, and the stance S₄ 4, together with a corresponding stance guide of the present invention, for the user to use thus achieving and holding stances S₂ 2 and S₄ 4 to realize corresponding health benefits, to be presently described. FIG. 2A illustrates the intermediary stance S₂ 2 together with a corresponding stance guide of the present invention, for the user to use thus achieving and holding stance S₂ 2. Comparing FIG. 2A with FIG. 1A, FIG. 1B, FIG. 1C and FIG. 1D reveals that stance S₂ 2 is a simplified intermediary stance of stance S₄ 4 in that, except for a simplified positioning and orientation of the user's arms and hands of stance S₂ 2, stance S₂ 2 is the same as stance S₄ 4. Specifically in stance S₂ 2, both upper arms 32 and 34 are naturally down with lower arms 36 and 38 pointing approximately in the x-direction. Both hands 40 and 42 are made into a fist with palm side up. As a side remark but still not illustrated here for simplicity, a fourth stance S₁ 1, very similar to stance S₂ 2, is essentially a mirror image of stance S₂ 2 regarding the positions of left/right foot and left/right arm.

Corresponding to the stance S₂ 2, the stance guide includes a front foot panel 100a and a rear foot panel 100c, connected to each other by a backbone beam 100d. Both foot panels 100a and 100c are oriented and located substantially along the x-axis and spaced apart from each other by an adjustable x-spacing for guiding and correctly positioning the user's feet 12 and 14. It is important to provide an adjustable x-spacing as individual members of a targeted user population are expected to exhibit somewhat different, albeit within a pre-determined range, of body sizes and spans between their feet. For the same reason, it is also important to provide adjustable x- and y-dimensions for the foot panels 100a and 100c. To further stabilize the stance guide, while not specifically shown here, the backbone beam 100d can have a stabilizing bar attached to its rear end and extending substantially in the y-direction. Notice that an extra center foot panel 100b is also included for additional flexibility of the stance guide. As illustrated in FIG. 2D for stance S₄ 4, the user can alternatively engage his feet 12 and 14 upon the center foot panel 100b and the rear foot panel 100c. This can be especially useful for a user with a short span between his feet. Additionally, the center foot panel 100b can be used for a different stance altogether and this will be presently illustrated. Thus, the foot panels 100a, 100b and 100c together with the backbone beam 100d provide the function of foot engagement and guidance for the stances S₂ 2 and S₄ 4.

Refer to FIG. 2B, FIG. 2C and FIG. 2D, to engage and guide the user's body under stance S₄ 4, an adjustable left elbow-engaging member 120a, an adjustable right elbow-engaging member 120b and an adjustable safety hand-engaging guard 120c are provided. The bottom inset of FIG. 2C illustrates the details of adjustment of the adjustable right elbow-engaging member 120b. The adjustable right elbow-engaging member 120b is a truss having a base bushing 130 affixed to the balancing bar 140a. A sliding rod 132 is slidably inserted and supported by the base bushing 130 with a rod lock 131 to fix the position of the sliding rod 132 after a sliding adjustment. At the top end of the sliding rod 132 is disposed an end mounting member 133 with a number of adjustable antennae 134 rotatably attached thereon forming a truss-like structure. Thus, after numerous degrees of mechanical adjustment of these adjustable antennae 134 according to a particular user's body size and arm length, etc., the position and orientation of the right elbow 46, upon its contact with the adjustable antennae 134, can be assured to conform to the stance S₄ 4 within a pre-determined range of user body and feet variation. By now it should also become clear that, if desired, an up to 6-axis adjustability (translation along the x-, y- and z-axis, rotation around the x-, y- and z-axis) of these adjustable antennae 134 can be implemented with more mechanical embodiments. Similarly, the position and orientation of the left elbow 44, upon its contact with the adjustable antennae of the adjustable left elbow-engaging member 120a, can also be assured to conform to the stance S₄ 4 within a pre-determined range of user body and feet variation. Likewise, by requiring that the user's right index finger 58 and rest of right fingers 62 insert through a finger loop of the adjustable safety hand-engaging guard 120c as illustrated, the user's right hand 42 can also be assured to conform to the stance S₄ 4 within a pre-determined range of user body and hand variation. In essence, the elbow-engaging members 120a and 120b and the safety hand-engaging guard 120c are adjustably attached to a balancing bar 140a. The balancing bar 140a can include a left end grip 140b and a right end grip 140c for helping the user to mount and dismount the stance guide.

As remarked before, due to the in-line positioning of his feet 12 and 14 for stance S₄ 4, a practitioner can fall from a tendency of body instability in the y-z plane. Therefore, with the substantial leveraging distance between the adjustable safety hand-engaging guard 120c and the foot panels 100a and 100c as provided, the adjustable safety hand-engaging guard 120c also helps to reduce the risk of an accidental fall of the practitioner while trying to achieve and hold the stance S₄ 4. Just like the case of foot panels 100a and 100c, the structural dimensions of the elbow-engaging members 120a and 120b and the safety hand-engaging guard 120c relevant to engaging and guiding the user's elbows and hands are made adjustable to accommodate a pre-determined population range of user body and hand variation. For example, the y-distance between the elbow-engaging members 120a and 120b can be accordingly made adjustable to accommodate a range of shoulder widths. For another example, the z-height of the adjustable safety hand-engaging guard 120c is accordingly made adjustable to accommodate a range of user heights, etc. To engage and guide the user's body under stance S₂ 2, the balancing bar 140a acts to engage and guide the formation and positioning of the user's hands 40 and 42, both made into a gripping fist with palm side up as illustrated in FIG. 2A. Hence, the elbow-engaging members 120a and 120b, the safety hand-engaging guard 120c together with the balancing bar 140a provide the function of body engagement and guidance for the stances S₂ 2 and S₄ 4. It is remarked that, in addition to the adjustable safety hand-engaging guard 120c, numerous other embodiments can be provided to help reducing the risk of an accidental fall of the practitioner while trying to achieve and hold the stance S₄ 4. For example, while not shown, the two end grips 140b and 140c can be properly extended toward the hips of the user to serve a similar function by preventing excessive movement of the user's hips. For another example, the two elbow-engaging members 120a and 120b can both be made of strong and highly rigid material to also serve a similar function by preventing excessive movement of the user's elbows 44 and 46.

To complete the stance guide, the balancing bar 140a is connected to the backbone beam 100d through a framing structure that in turn includes a connected set of left supporting truss 140d, a right supporting truss 140e and a bottom supporting truss 140f. Again, the structural dimensions of the framing structure relevant to engaging and guiding the user's elbows and hands can be made adjustable to accommodate a pre-determined population range of user body and hand variation. For example, the height of both supporting trusses 140d and 140e can be made adjustable to accommodate a range of user heights so that, when the user exerts an effort of lifting up his fists under stance S₂ 2, a corresponding downward pressure will be induced on the muscles of both of his legs 24 and 26 further enhancing the intensity of practice. It is remarked that, in addition to the adjustable safety hand-engaging guard 120c, numerous other embodiments can be provided to help reducing the risk of an accidental fall of the practitioner while trying to achieve and hold the stance S₄ 4. For example, while not shown, two hip safe guard members can be added on the supporting trusses 140d and 140e and properly extended toward the hips of the user to serve a similar function by preventing excessive movement of the user's hips.

By now it should become clear that using the stance guide as illustrated should help the user achieve and hold stances S₂ 2 and S₄ 4. Additionally, with the numerous mechanical adjustments available to the various dimensions of the stance guide, it should also be clear that the stance guide should help the user achieve and hold stances S₁ 1 and S₃ 3 as well, being respectively a mirror image of stance S₂ 2 and stance S₄ 4.

The regular achievement and holding of stance S₁ 1 and stance S₂ 2, respectively being an intermediary of stance S₃ 3 and stance S₄ 4, is known to provide the following health benefits:
(1) Direct development of stronger body muscles and better body flexibility.
(2) Increasing the easiness and efficiency for bridging stance S₁ 1 to stance S₃ 3 and for bridging stance S₂ 2 to stance S₄ 4.
   Thus, the stance guide allows its user to effectively and gradually develop stronger muscles and flexibility in order to perform the next, more advanced stances S₃ 3 and S₄ 4. During the bridging period, the user should practice stances S₁ 1 and S₂ 2 about three times a day at about five minutes duration each time then move on to stances S₃ 3 and S₄ 4 when he/she feels comfortable. While regularly achieving and holding stance S₃ 3 and stance S₄ 4, the practitioner will feel tensed, sore and slightly painful on his/her calf and back of knees. As a result, it has been known to cause a reduction of frequent and excess habitual urination for many of those practitioners having these problems. It was also known to cause a reduction of the amount of discharge per urination. One theory behind these observed results is that these feelings indicate that the related body muscles and nerves are stretched and stimulated, hence sending a corresponding signal to the practitioner's brain. Consequently, the muscles and nerves of the practitioner's bladder will also be strengthened hence the observed results. Additional related health benefits include: preservation of minerals and electrolytes in the body, indirect reduction of incidents of stroke and heart attack from the reduction of urination frequency of the elders (abrupt temperature change from a warm bedroom to a cold bathroom), indirect avoidance of falling and tripping (walking in darkness in the middle of bed time) and the enhancement of the quality of sleep. In essence, the regular achievement and holding of stance S₃ 3 and stance S₄ 4 is known to provide the following health benefits:
   (1) Direct development of stronger body muscles and better body flexibility.
   (2) Indirect strengthening of the bladder muscles and nerves causing a reduction of frequent and excess habitual urination for those having these problems.
      For the above health benefits to be significant, the holding period for the stance S₃ 3 and the stance S₄ 4 are further recommended to be progressed from about one (1) minute to about ten (10) minutes each time with a range of practicing frequency to be progressed from about two (2) times to about ten (10) times a day. Nominally, a user of the stance guide should practice three times a day at five minutes each time. In this way, in about two weeks, the above health benefits should materialize.

By now it should become clear to those skilled in the art that the various exemplary embodiments of the stance guide can be easily adapted and modified to suit additional applications without departing from the spirit and scope of this invention. For example, the function of foot engagement and guidance for the stances S₂ 2 and S₄ 4 does not have to be only provided by the foot panels 100a, 100b and 100c together with the backbone beam 100d. Instead, foot engagement and guidance can alternatively be provided by a rectangular-shaped base platform, in the x-y plane, with three locationally adjustable foot depressions thereon. For another example, one or more of the foot panels 100a, 100b and 100c can instead be replaced by a slipper-like structure. The function of body engagement and guidance, if desirable, can include an angle bracket erected from the base platform for engaging and guiding the user's front knee. A straight bracket can also be erected from the base platform for engaging and guiding the user's rear knee. Two locationally adjustable beams, along the y-direction, can be added on top of the balancing bar 140a and extending toward the user's shoulders 30 for engaging and guiding the user's shoulders. The adjustable antennae 134 of the elbow-engaging members 120a and 120b can instead be replaced by a spherical element for engaging and guiding the user's elbow albeit with less accuracy. An interior divider bar can be added to the finger loop of the adjustable safety hand-engaging guard 120c to further insure the separation of the user's right index finger 58 from the rest of right fingers 62. For increased structural rigidity, an angle brace can be added between each of the supporting trusses 140d, 140e and the bottom supporting truss 140f. If desired, the bottom supporting truss 140f and the supporting trusses 140d, 140e can even be combined into a single wall structure.

Regarding material for construction, the key structural members of backbone beam 100d, bottom supporting truss 140f, supporting trusses 140d, 140e, balancing bar 140a and end grips 140b, 140c are preferably made of knock down steel frame although some or all of them can alternatively be made of other materials such as metal, plastic, wood, glass or ceramic as long as sufficient structural rigidity of the stance guide is preserved. The material selection for the remaining members of the stance guide can come from an even wider range.

Another embodiment of the present invention, as illustrated in FIG. 2A and FIG. 2C, is a rear heel sensing device that includes a mechanical switch 102, an adjustable timer and display device 120d for sensing, timing and displaying the duration of correctness of engagement of the user's feet. The mechanical switch 102 further includes a stationary contact 102a located beneath the rear foot panel 100c, a moving contact 102b, activated by the user's left heel 16a through a heel engaging element 102d and a transmitting spring 102c, to make or break with the fixed contact 102a. Two signal wires 102e electrically connect the mechanical switch 102 to the adjustable timer and display device 120d. The adjustable timer and display device 120d has a time display 126 and associated control knobs and switches 124 for its operation. The adjustable timer and display device 120d also has an optional image display 122 for selectably displaying one or more of the stances S₁ 1, S₂ 2, S₃ 3 and S₄ 4 as a visual aid to achieving and holding these stances. Like before, the x- and y-location of the mechanical switch 102 can be made adjustable to suit a pre-determined range of user foot spans. Thus, should the user's left heel 16a firmly touch the ground the mechanical switch 102 will be closed signifying a correct heel placement and the duration of correct heel placement can be timed with a timing device and displayed on the time display 126. On the other hand, if the user's left heel 16a does not firmly touch the ground the mechanical switch 102 will stay open signifying an incorrect heel placement. While not shown here for simplicity, the adjustable timer and display device 120d can include a signaling device such as an indicator light, an audible device or even a mechanical vibrator touching thus stimulating the user's body to alert the user of the incorrect heel placement. Alternatively, the rear heel sensing device can be implemented with a linear position sensor, an optical interrupter, an acoustic interrupter, a capacitive proximity sensor, a piezoelectric force sensor, etc. Likewise, the timing device can be implemented with an electronic timer, a mechanical timer, etc. The time display 126 and the image display 122 can be implemented with an LED display, an incandescent display, a plasma display, an LCD display, a CRT display, etc.

By now it should become clear to those skilled in the art that, to help insuring correctness of the user's stance, additional embodiment of the present invention can include the sensing of positioning or orientation of other parts of the body that is relevant to the stance under consideration. For example, a front knee angle sensing and signaling device can be added to insure the correct angle of the front knee. For another example, a rear knee sensing and signaling device can be added to insure the straightness of the rear knee. For a third example, an additional front heel sensing and signaling device can be added and having whose output signal compared with that of the rear heel sensing device to insure that the body weight is kept on the front foot. For a fourth example, elbow sensing and signaling devices can be added to insure the correctness of the positioning of the elbows.

Yet another embodiment of the present invention is that an optional pre-recorded video medium can be included with the stance guide to demonstrate to the user, upon playing back, the actual achieving and holding of each of the desired stances as a training tool. As examples, the video medium can be a VHS cassette, a DVD disk or a VCD disk.

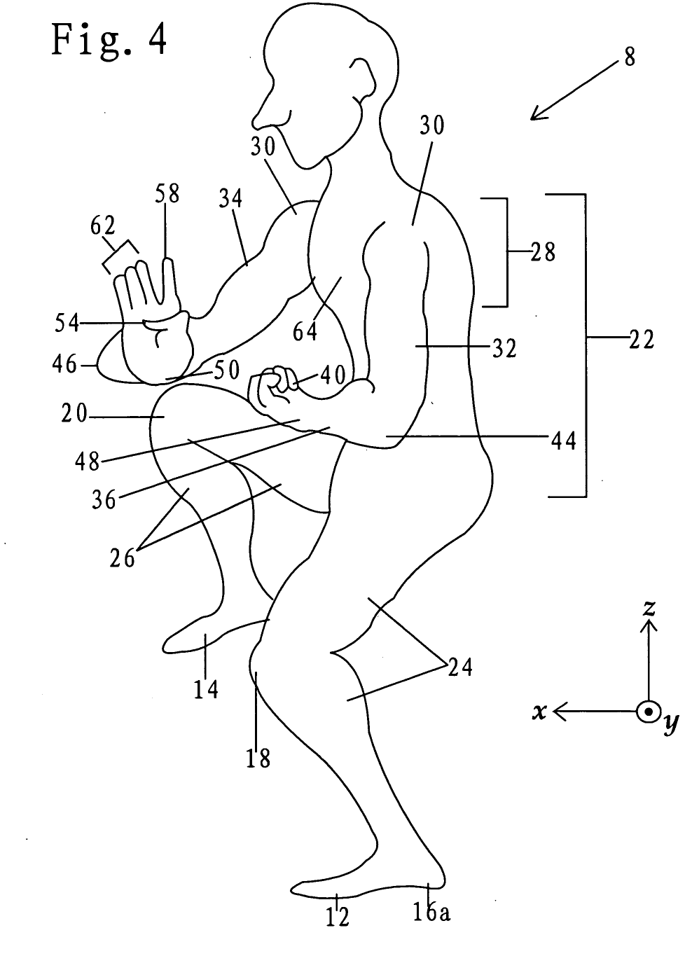

FIG. 4 illustrates another stance, labeled stance S₈ 8, for the user of the present invention to achieve and hold to realize a corresponding health benefit. To help the illustration, an x-y-z Cartesian coordinate is introduced wherein the x-direction is where the user's body faces, the y-direction runs from the user's right shoulder toward his left shoulder and the z-direction runs vertically upwards. As illustrated, the left heel 16a needs to be against the ground. Right foot 14 is positioned in front of left foot 12 with right knee 20 bent thus right foot 14 held as high in the air as possible. Left knee 18 should also be bent as much as possible. The overall back 22 should lean slightly forward with upper back 28 arched and shoulders 30 curved forward. The upper right arm 34 should be positioned ahead of (+x direction) the upper left arm 32. Right elbow 46 should be positioned slightly ahead of (+x direction) right wrist 50. The right hand 42 should form an open-palm, Christian style praying orientation except having a bent right thumb 54, pointing in the x-direction, and having a right index finger 58 separated from the rest of right fingers 62, the right thumb 54 positioned at the same height as but about five (5) inches ahead of (+x direction) the heart 64 The lower left arm 36 should be pointing approximately in the negative y-direction with the left elbow 44 slightly ahead of (+x direction) the left wrist 48, the left hand 40 made into a fist with palm side up and positioned about three (3) inches below the user's belly button 66. While not illustrated here for simplicity, yet another stance S₇, very similar to stance S₈ 8, is essentially a mirror image of stance S₈ 8 regarding the positions of left/right foot and left/right arm. For example, in stance S₇ the left foot 12 would be positioned in front of the right foot 14 with left knee 18 bent thus the left foot 12 held as high in the air as possible, etc.

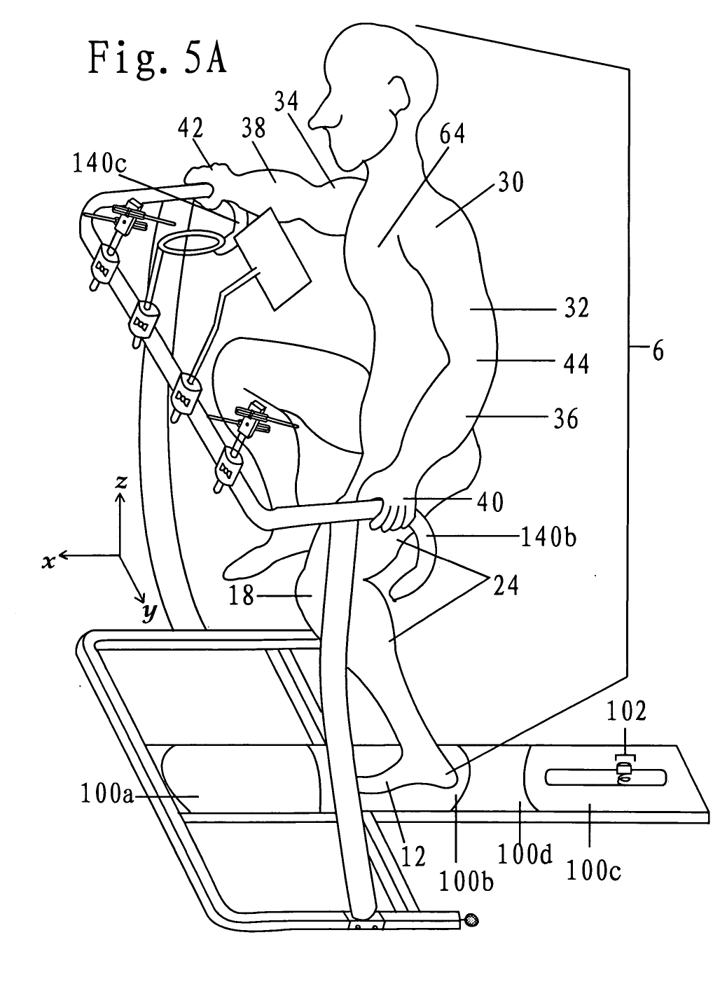

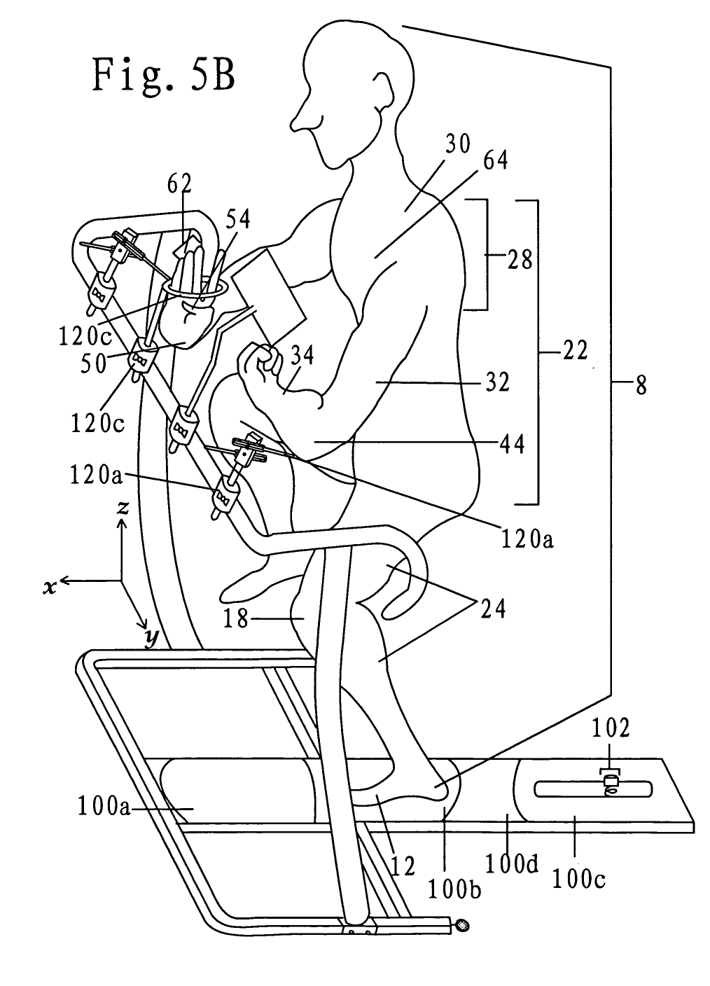

FIG. 5A and FIG. 5B illustrate an intermediary stance of stance S₈ 8, labeled stance S₆ 6, together with a corresponding stance guide of the present invention, for the user to use thus achieving and holding S₆ and S₈ to realize corresponding health benefits. Notice the difference between stance S₆ 6 and stance S₈ 8 is that, in stance S₆ 6 of FIG. 5A, the upper back 28 and shoulders 30 are relaxed, both upper arms 32 and 34 are tilted in the y-z plane so as to slightly open up the user's arm pits with both lower arms 36 and 38 pointing generally in the x-direction and both hands 40 and 42 forming a gripping position as if pushing a wheel barrel. While also not illustrated here for simplicity, yet another stance S₅ 5, very similar to stance S₆ 6, is essentially a mirror image of stance S₆ 6 regarding the positions of left/right foot and left/right arm. In FIG. 5A, the center foot panel 100b serves to properly position the user's left foot 12 while the left end grip 140b and the right end grip 140c respectively serves to position the user's left hand 40 and right hand 42 under stance S₆ 6. Thus, the front foot panel 100a and the rear foot panel 100c together with its mechanical switch 102 are left unused here. In FIG. 5B the adjustable left elbow-engaging member 120a, the adjustable right elbow-engaging member 120b and the adjustable safety hand-engaging guard 120c function under stance S₅ 8 the same way as they did under stance S₄ 4.

By now it should become clear that using the stance guide as illustrated should help the user achieve and hold stances S₆ 6 and S₅ 8. Additionally, with the numerous mechanical adjustments available to the various dimensions of the stance guide, it should also be clear that the stance guide should help the user achieve and hold stances stance S₅ 5 and stance S₇ 7 as well, being respectively a mirror image of stance S₆ 6 and stance S₅ 8.

The regular achievement and holding of stance S₅ 5 and stance S₆ 6, respectively being an intermediary of stance S₇ 7 and stance S₈ 8, is known to provide the following health benefits:
(1) Direct development of stronger body muscles and better body flexibility.
(2) Increasing the easiness and efficiency for bridging stance S₅ 5 to stance S₇ 7 and for bridging stance S₆ 6 to stance S₈ 8.
   Thus, the stance guide allows its user to effectively and gradually develop stronger muscles and flexibility in order to perform the next, more advanced stances S₇ 7 and S₈ 8. During the bridging period, the user should practice stances S₅ 5 and S₆ 6 about three times a day at about five minutes duration each time then move on to stances S₇ 7 and S₈ 8 when he/she feels comfortable. With the practitioner regularly achieving and holding stance S₇ 7 and S₈ 8, it has been known to help enhancing the quality of sleep, strengthen leg muscles, reduce weight and prevent falling and stripping due to stronger legs. In essence, the regular achievement and holding of stance S₇ 7 and stance S₈ 8 is known to provide the following health benefits:
   (1) Direct development of stronger body muscles and better body flexibility.
   (2) Indirect enhancement of sleep quality and reduction of body weight for those having these problems.
      For the above health benefits to be significant, the holding period for the stance S₇ 7 and the stance S₈ 8 are further recommended to be progressed from about one (1) minute to about ten (10) minutes each time with a range of practicing frequency to be progressed from about two (2) times to about ten (10) times a day. Nominally, a user of the stance guide should practice three times a day at five minutes each time. In this way, in about two weeks, the above health benefits should materialize.

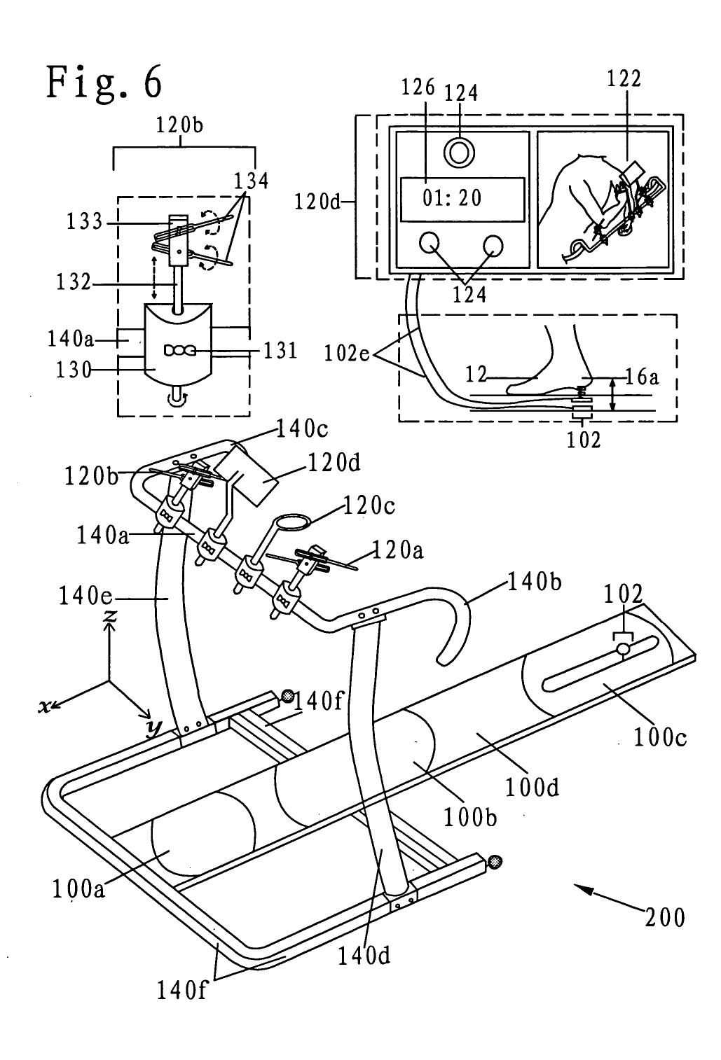

To summarize with clarity, FIG. 6 illustrates only the stance guide of the present invention for the user to use thus progressively achieving and holding a number of stances S₁, S₂, S₃, S₄, S₅, S₆, S₇ and S₈ to realize a number of corresponding health benefits.

As described with numerous exemplary embodiments, a stance guide and method of use are proposed to help the user achieve and hold a number of stances S₁, where j=(1, 2, . . . N) and N>=1, so that the achievement and holding of each Sⱼ provides a corresponding health benefit to the user. However, for those skilled in this field, these exemplary embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

1. A stance guide comprising:
(a) a foot engaging means for guiding and engaging at least one foot of the user;
(b) a body engaging means for guiding and engaging at least one part of the user's body; and
(c) a framing structure connected to said foot engaging means and said body engaging means
whereby the stance guide helps the user achieve and hold one or more pre-determined stances Sⱼ, where j=(1, 2, . . . N) and N>=1, such that the achievement and holding of each Sⱼ provides a corresponding health benefit to the user.

2. The stance guide of claim 1 wherein the structural dimensions of the foot engaging means relevant to guiding and engaging the user's feet and body are adjustable thereby accommodating a pre-determined range of user body and feet variation.

3. The stance guide of claim 1 wherein the structural dimensions of the body engaging means relevant to guiding and engaging the user's feet and body are adjustable thereby accommodating a pre-determined range of user body and feet variation.

4. The stance guide of claim 1 wherein the structural dimensions of the framing structure relevant to guiding and engaging the user's feet and body are adjustable thereby accommodating a pre-determined range of user body and feet variation.

5. The stance guide of claim 1 wherein said body engaging means further comprises a hand engaging means for guiding and engaging at least one of user's hands.

6. The stance guide of claim 1 wherein the foot engaging means further comprises a foot engagement sensing and signaling means for sensing and signaling the correctness of engagement of the user's feet.

7. The stance guide of claim 6 wherein the foot engagement sensing and signaling means further comprises a timing device for timing the duration of correct engagement of the user's feet.

8. The stance guide of claim 1 wherein the body engaging means further comprises a body engagement sensing and signaling means for sensing and signaling the correctness of engagement of the user's body.

9. The stance guide of claim 8 wherein the body engagement sensing and signaling means further comprises a timing device for timing the duration of correct engagement of the user's body.

10. The stance guide of claim 1 further comprises an optional pre-recorded video medium demonstrating the actual achieving and holding of said stances Sⱼ as a training tool.

11. The stance guide of claim 10 wherein said video medium is a VHS cassette, a DVD disk or a VCD disk.

12. The stance guide of claim 1 further comprises an optional display device, connected to said framing structure, for selectably displaying one or more of said stances Sⱼ as a visual aid to achieving and holding said stances Sⱼ.

13. The stance guide of claim 1 further comprises an optional display device, connected to said body engaging means, for selectably displaying one or more of said stances Sⱼ as a visual aid to achieving and holding said stances Sⱼ.

14. The stance guide of claim 1 wherein the body engaging means further comprises a safe guard means for reducing the risk of an accidental fall of the user while trying to achieve and hold said stances Sⱼ.

15. The stance guide of claim 1 wherein the framing structure further comprises a safe guard means for reducing the risk of an accidental fall of the user while trying to achieve and hold said stances Sⱼ.

16. The stance guide of claim 5 wherein said stances Sⱼ comprise S₁, S₂, S₃ and S₄ being characterized by, with an x-y-z Cartesian coordinate wherein the x-direction is where the user body faces, the y-direction runs from the user's right shoulder toward his left shoulder and the z-direction runs vertically upwards:
(a) S₁: both feet flat with heels against the ground and centered in a sagittal plane of the body, left foot in front of and spaced as far ahead of right foot as possible, left knee bent about 110 degrees, right knee as straight as possible while keeping the body weight on the left foot, overall back formed a straight line with the right leg, upper back arched and shoulders curved forward, upper arms naturally down, lower arms pointing in the x-direction with both hands made into a fist palm side up while continuously keeping the body weight on the left foot;
(b) S₂: mirror image of S₁ regarding left/right foot and left/right arm;
(c) S₃: feet, legs, overall back, upper back and shoulders same as S₁, upper left arm ahead of upper right arm with left elbow slightly ahead of left wrist, left hand in an open-palm, Christian style praying orientation except having a bent thumb, in the x-direction, and having an index finger separated from the rest of the fingers, left thumb positioned at the same height as but about five (5) inches ahead of the heart, lower right arm pointing approximately in the y-direction with right elbow slightly ahead of right wrist, right hand made into a fist with palm side up and positioned about three (3) inches below the user's belly button while continuously keeping the body weight on the left foot; and
(d) S₄: mirror image of S₃ regarding left/right foot and left/right arm and wherein, accordingly:
(e) said foot engaging means further comprises a front foot panel and a rear foot panel, connected to each other by a backbone beam with both panels oriented and located substantially along the x-axis and spaced apart by an x-spacing that is adjustable, for guiding and correctly positioning the user's feet of stances S₁, S₂, S₃ and S₄;
(f) said body engaging means further comprises two elbow-engaging members, each being a truss having an up to 6-axis adjustability, for touching thus correctly positioning the user's elbows of stances S₃ and S₄; and
(g) said framing structure further comprises a balancing bar and a supporting truss oriented substantially parallel to the y-z plane and connected to said balancing bar and said backbone beam, said balancing bar oriented along substantially the y-direction and connected to said two elbow-engaging members, said balancing bar for guiding thus correctly positioning the user's fists of stances S₁ and S₂ through fist gripping.
such that the achievement and holding of stances S₃ and S₄ provides the following health benefits:
(3) direct development of stronger body muscles and better body flexibility; and
(4) indirect strengthening of the bladder muscles and nerves causing a reduction of frequent and excess habitual urination and the achievement and holding of stances S₁ and S₂, respectively being an intermediary of stance S₃ and stance S₄, provides the following health benefits:
(5) direct development of stronger body muscles and better body flexibility; and
(6) increasing the easiness and efficiency for bridging stances S₁ to S₃ and for bridging stances S₂ to S₄.

17. The stance guide of claim 16 wherein said hand engaging means further comprises a hand loop oriented substantially in the x-y plane and adjustably, in the z-direction, connected to said framing structure, said hand loop being disposed for guiding and correctly positioning the user's open-palmed hand of stances S₃ and S₄.

18. The stance guide of claim 16 wherein at least one of said front foot panel and said rear foot panel further comprise a foot engagement sensing and signaling device attached thereto for sensing and signaling the correctness of engagement of at least one of user's feet.

19. The stance guide of claim 18 wherein the location of said sensing and signaling device is adjustable in the x-y plane.

20. The stance guide of claim 18 wherein the foot engagement sensing function of said sensing and signaling device is implemented with a mechanical switch, a linear position sensor, an angle sensor, an optical interrupter, an acoustic interrupter, a capacitive proximity sensor, a piezoelectric force sensor.

21. The stance guide of claim 18 wherein the signaling function of said sensing and signaling device is implemented with an audible device, a display device or a body-stimulating device.

22. The stance guide of claim 16 wherein the backbone beam further comprises a stabilizing bar attached to the rear end of said backbone beam and extending substantially in the y-direction therefrom for stabilizing the stance guide.

23. The stance guide of claim 16 wherein each of said foot engaging means, said body engaging means and said framing structure is made of material selected from the group consisting of metal, plastic, wood, glass or ceramic.

24. The stance guide of claim 16 wherein, for said health benefit to be significant, the holding period for said stances S₁ and S₂ are further recommended to be progressed from about one (1) minute to about ten (10) minutes a day.

25. The stance guide of claim 16 wherein, for said health benefit to be significant, the holding period for said stances S₃ and S₄ are further recommended to be progressed from about one (1) minute to about ten (10) minutes each time with a range of practicing frequency to be progressed from about two (2) times to about ten (10) times a day.

26. The stance guide of claim 5 wherein said stances Sⱼ comprise S₅, S₆, S₇ and S₈ being characterized by, with an x-y-z Cartesian coordinate wherein the x-direction is where the user body faces, the y-direction runs from the user's right shoulder toward his left shoulder and the z-direction runs vertically upwards:
(a) S₅: right heel against the ground, left foot in front of right foot, left knee bent with left foot as high in the air as possible, right knee bent as much as possible, overall back leaned slightly forward, upper back and shoulders relaxed, both upper arms tilted in the y-z plane so as to slightly open up the arm pits with both lower arms pointing in the x-direction and both hands forming a gripping position as if pushing a wheel barrel;
(b) S₆: mirror image of S₅ regarding left/right foot and left/right arm;
(c) S₇: feet, legs and overall back same as S₅, upper back arched and shoulders curved forward, upper arms naturally down, upper left arm ahead of upper right arm with left elbow slightly ahead of left wrist, left hand in an open-palm, Christian style praying orientation except having a bent thumb, in the x-direction, and having an index finger separated from the rest of the fingers, left thumb positioned at the same height as but about five (5) inches ahead of the heart, lower right arm pointing approximately in the y-direction with right elbow slightly ahead of right wrist, right hand made into a fist with palm side up and positioned about three (3) inches below the user's belly button; and
(d) S₈: mirror image of S₇ regarding left/right foot and left/right arm and wherein, accordingly:
(e) said foot engaging means further comprises a front foot panel, a center foot panel and a rear foot panel, connected to one another by a backbone beam with all panels oriented and located substantially along the x-axis and spaced apart by an adjustable front x-spacing and an adjustable rear x-spacing, for guiding and correctly positioning the user's feet of stances S₅, S₆, S₇ and S₈;
(f) said body engaging means further comprises two elbow-engaging members, each being a truss having an up to 6-axis adjustability, for touching thus correctly positioning the user's elbows of stances S₇ and S₈; and
(g) said framing structure further comprises a balancing bar and a supporting truss oriented substantially parallel to the y-z plane and connected to said balancing bar and said backbone beam, said balancing bar oriented along substantially the y-direction and connected to said elbow-engaging members, said balancing bar further comprising two end grips, each pointing in the negative x-direction, for guiding thus correctly positioning the user's hands of stances S₅ and S₆ through fist gripping
such that the achievement and holding of stances S₇ and S₈ provides the following health benefits:
(1) direct development of stronger body muscles and better body flexibility; and
(2) indirect enhancement of sleep quality and reduction of body weight
and the achievement and holding of stances S₅ and S₆, respectively being an intermediary of stance S₇ and stance S₈, provides the following health benefits:
(3) direct development of stronger body muscles and better body flexibility; and
(4) increasing the easiness and efficiency for bridging stances S₅ to S₇ and for bridging stances S₆ to S₈.

27. The stance guide of claim 26 wherein said hand engaging means further comprises a hand loop oriented substantially in the x-y plane and adjustably, in the z-direction, connected to said framing structure, said hand loop being disposed for guiding and correctly positioning the user's open-palmed hand of stances S₇ and S₈.

28. The stance guide of claim 26 wherein at least one of said front foot panel and said rear foot panel further comprise a foot engagement sensing and signaling device attached thereto for sensing and signaling the correctness of engagement of at least one of user's feet.

29. The stance guide of claim 28 wherein the location of said sensing and signaling device is adjustable in the x-y plane.

30. The stance guide of claim 26 wherein the backbone beam further comprises a stabilizing bar attached to the rear end of said backbone beam and extending substantially in the y-direction therefrom for stabilizing the stance guide.

31. The stance guide of claim 26 wherein, for said health benefit to be significant, the holding period for said stances S₅ and S₆ are further recommended to be progressed from about one (1) minute to about ten (10) minutes a day.

32. The stance guide of claim 26 wherein, for said health benefit to be significant, the holding period for said stances S₇ and S₈ are further recommended to be progressed from about one (1) minute to about ten (10) minutes each time with a range of practicing frequency to be progressed from about two (2) times to about ten (10) times a day.

33. A method of helping a person achieve and hold one or more pre-determined stances Sⱼ, where j=(1, 2, . . . N) and N>=1, such that the achievement and holding of each Sⱼ provides a corresponding health benefit to the person, the method comprising:
(a) providing a foot engaging means for guiding and engaging at least one foot of the person;
(b) providing a body engaging means for guiding and engaging at least one part of the person's body;
(c) providing a framing structure properly dimensioned and properly connected to the foot engaging means and the body engaging means; and
(d) for each stance Sⱼ, providing a corresponding instruction Iⱼ, where j=(1, 2, . . . N) and N>=1, to the person for achieving and holding said Sⱼ while engaging said foot engaging means and said body engaging means
thereby helping the person achieve and hold said Sⱼ.

34. The method of claim 33 wherein providing said foot engaging means further comprises making the structural dimensions of the foot engaging means relevant to guiding and engaging the person's feet and body adjustable thereby accommodating a pre-determined range of user body and feet variation.

35. The method of claim 33 wherein providing said body engaging means further comprises making the structural dimensions of the body engaging means relevant to guiding and engaging the person's feet and body adjustable thereby accommodating a pre-determined range of user body and feet variation.

36. The method of claim 33 wherein providing said framing structure further comprises making the structural dimensions of the framing structure relevant to guiding and engaging the person's feet and body adjustable thereby accommodating a pre-determined range of user body and feet variation.

37. The method of claim 33 wherein providing said body engaging means further comprises providing a hand engaging means for guiding and engaging at least one of user's hands.

38. The method of claim 33 wherein providing said foot engaging means further comprises providing a foot engagement sensing and signaling means for sensing and signaling the correctness of engagement of the person's feet.

39. The method of claim 38 wherein providing said foot engagement sensing and signaling means further comprises providing a timing device for timing the duration of correct engagement of the user's feet.

40. The method of claim 33 wherein providing said body engaging means further comprises providing a body engagement sensing and signaling means for sensing and signaling the correctness of engagement of the person's body.

41. The method of claim 40 wherein providing said body engagement sensing and signaling means further comprises providing a timing device for timing the duration of correct engagement of the user's body.

42. The method of claim 33 wherein providing said corresponding instruction Iⱼ further comprises providing an optional pre-recorded video medium demonstrating the actual achieving and holding of said stances Sⱼ as a training tool.

43. The method of claim 42 wherein said video medium is a VHS cassette, a DVD disk or a VCD disk.

44. The method of claim 33 wherein providing said corresponding instruction Iⱼ further comprises providing an optional display device, connected to said framing structure, for selectably displaying one or more of said stances Sⱼ as a visual aid to achieving and holding said stances Sⱼ.

45. The method of claim 33 wherein providing said corresponding instruction Iⱼ further comprises providing an optional display device, connected to said body engaging means, for selectably displaying one or more of said stances Sⱼ as a visual aid to achieving and holding said stances Sⱼ.

46. The method of claim 33 wherein providing said body engaging means further comprises providing a safe guard means for reducing the risk of an accidental fall of the person while trying to achieve and hold said stances Sⱼ.

47. The method of claim 33 wherein providing said framing structure further comprises providing a safe guard means for reducing the risk of an accidental fall of the person while trying to achieve and hold said stances Sⱼ.

48. The method of claim 33 wherein, for said health benefit to be significant, providing said corresponding instruction Iⱼ further comprises providing a pre-determined recommended range of holding period for said stance Sⱼ.

49. The method of claim 33 wherein, for said health benefit to be significant, providing said corresponding instruction Iⱼ further comprises providing a pre-determined recommended range of frequency for practicing said stance Sⱼ.
